(19) United States
(12) Patent Application Publication
(10) Pub. No.: US 2023/0115951 A1
(43) Pub. Date: Apr. 13, 2023

(54) ELECTRONIC DEVICE HAVING FINGERPRINT SENSING FUNCTION

(71) Applicant: Egis Technology Inc., Hsinchu City (TW)

(72) Inventors: Yu-Hsuan Lin, Hsinchu City (TW); Yao-Li Huang, Hsinchu City (TW); Chung-Yi Wang, Hsinchu City (TW); Sheng Ruei Hsu, Hsinchu City (TW)

(73) Assignee: Egis Technology Inc., Hsinchu City (TW)

(21) Appl. No.: 17/913,168

(22) PCT Filed: Oct. 23, 2020
(86) PCT No.: PCT/CN2020/123213

§ 371 Date: Sep. 21, 2022

Related U.S. Application Data
(60) Provisional application No. 63/015,659, filed on Apr. 26, 2020.

(51) Int. Cl. G06F 3/041; G09G 3/36; G06V 40/13

(52) U.S. Cl. CPC G06F 3/0412; G06F 3/0416; G09G 3/3607; G06V 40/13; G09G 2300/0452; G09G 2310/08; G09G 2310/0291; G09G 2300/0426

(57) ABSTRACT

Provided is an electronic device comprising a touch display panel and an integrated chip. The touch display panel comprises a pixel array. The integrated chip is electrically connected to the pixel array. The integrated chip comprises a fingerprint sensing circuit and a display driving circuit. The fingerprint sensing circuit and the display driving circuit are electrically connected to multiple display data lines and sensing data lines through of the same pin. The multiple display data lines are respectively electrically connected to multiple color sub-pixels of the pixel array. The sensing data lines are electrically connected to multiple fingerprint sensing pixels of the pixel array. The multiple color sub-pixels are multiple liquid crystal display pixels.

### BACKGROUND

### Technical Field

The invention relates to a device, in particular to an electronic device having a fingerprint sensing function.

### Description of Related Art

In recent years, fingerprint identification technology has been widely applied in various electronic devices to provide various identity login or identity verification functions. The currently existing technical principles of fingerprint identification include an optical mode, a capacitive mode, a thermal-sensitive mode, an ultrasonic mode, etc. In this regard, since a fingerprint sensor in the above modes is disposed in an electronic device, the fingerprint sensor is typically required to occupy a part of the device volume of the electronic device. Moreover, a general fingerprint sensor may be disposed or externally mounted below a screen, at a Home button, or at a rear part of a device body, for example, of the electronic device. In other words, the general fingerprint sensor increases the overall device volume or thickness of the electronic device, and thus leads to an increase in the manufacturing cost of the electronic device. In view of this, several embodiments of solutions are provided below.

### SUMMARY

The invention is directed to an electronic device which can provide a large-area fingerprint sensing function.

According to an embodiment of the invention, an electronic device of the invention includes a touch display panel and an integrated chip. The touch display panel includes a pixel array. The integrated chip is electrically connected to the pixel array. The integrated chip includes a fingerprint sensing circuit and a display driving circuit. The fingerprint sensing circuit and the display driving circuit are electrically connected to a plurality of display data lines and sensing data lines through a same pin. The plurality of display data lines are electrically connected to respectively a plurality of color sub-pixels of the pixel array. The sensing data lines are electrically connected to a plurality of fingerprint sensing pixels of the pixel array. The plurality of color sub-pixels are a plurality of liquid crystal display pixels.

Based on the foregoing, in the electronic device of the invention, full-screen fingerprint sensing function may be realized by forming a plurality of fingerprint sensing pixels in the pixel array of the touch display panel. Moreover, since the fingerprint sensing pixels are embedded in the touch display panel, the electronic device of the invention can effectively reduce the space of functional modules required for fingerprint sensing, thus reducing the overall device volume or thickness of the electronic device.

To make the aforementioned features and advantages of the invention more comprehensible, embodiments accompanied with drawings are described in detail as follows.

### BRIEF DESCRIPTION OF THE DRAWINGS

FIG. 1 is a schematic diagram of an electronic device of an embodiment of the invention.

FIG. 2 is a schematic circuit diagram of a part of a pixel array of an embodiment of the invention.

FIG. 3 is a schematic circuit diagram of an integrated chip and a switch circuit of an embodiment of the invention.

FIG. 4 is a schematic diagram of internal functional circuits of an integrated chip of an embodiment of the invention.

FIG. 5 is a signal timing diagram of a plurality of signals for operating an integrated chip of an embodiment of the invention.

### DESCRIPTION OF REFERENCE SIGNS

100: electronic device;

110: touch display panel;

120: pixel array;

130: integrated chip;

131: fingerprint sensing circuit;

131_1: amplifier;

131_2: analog-to-digital converter;

131_3: digital processor;

132: display driving circuit;

132_1: source amplifier;

132_2: timing control circuit;

133: control circuit;

141, 142, 143, 144: demultiplexer;

D1 to D3, D5: display data line;

D4: sensing data line;

DS: display driving signal;

G1, G2: gate line;

GS1: scan signal;

FS: sensing signal;

M_1 to M_4, S1, S2: switch signal;

N1: pin;

T1 to T6: transistor;

t0 to t5: time.

### DESCRIPTION OF THE EMBODIMENTS

Reference will now be made in detail to exemplary embodiments of the invention, examples of which are illustrated in the accompanying drawings. Wherever possible, the same reference numerals are used in the drawings and description to denote the same or like parts.

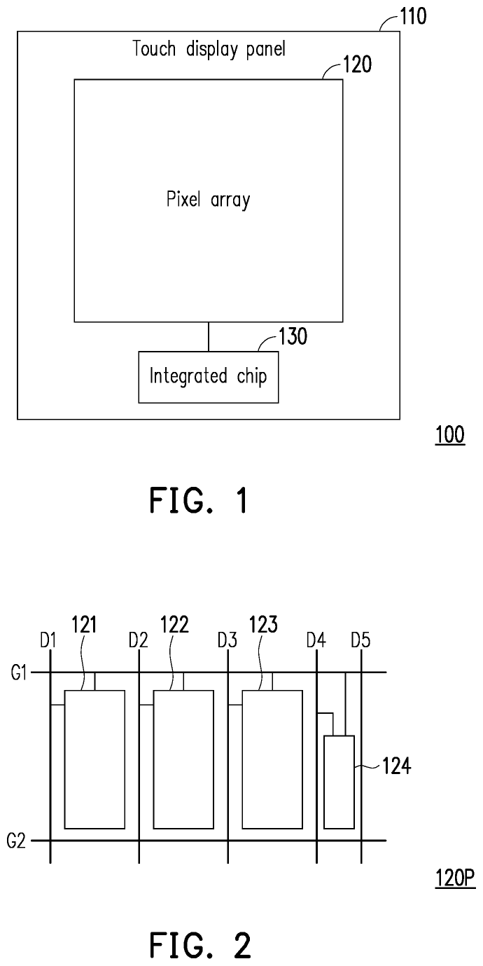

FIG. 1 is a schematic diagram of an electronic device of an embodiment of the invention. With reference to FIG. 1, an electronic device 100 includes a touch display panel 110, a pixel array 120, and an integrated chip (IC) 130. The pixel array 120 is electrically connected to the integrated chip 130. In this embodiment, the touch display panel 110 may include, for example, a glass substrate and a touch panel. The pixel array 120 is formed on the glass substrate in an active area (AA) of the touch display panel 110. The integrated chip 130 is formed in a peripheral area (PA) of the touch display panel 110. In this embodiment, the integrated chip 130 includes a fingerprint sensing circuit 131 and a display driving circuit 132. It is worth noting that an in-cell-type fingerprint, touch, and display panel structure may be adopted for the touch display panel 110 of this embodiment. The integrated chip 130 may be a fingerprint, touch, display driver integrated (FTDDI) chip.

In this embodiment, the integrated chip 130 may be electrically connected to a plurality of display pixels and a plurality of fingerprint sensing pixels in the pixel array 120 through a same pin, and the integrated chip 130 drives a display module of the touch display panel 110 and the touch display panel 110 in a time-sharing manner. In other words, the integrated chip 130 of this embodiment may drive the display module and the fingerprint sensing module in the touch display panel 110 through fewer pins, thus effectively reducing the space occupied by pins and circuits in the electronic device 100.

In this embodiment, the electronic device 100 is, for example, a smart phone, a tablet computer, a game console, or other electronic products having a fingerprint identification function.

The touch display panel 110 may be, for example, a liquid crystal display (LCD) panel. Therefore, a plurality of color sub-pixels of the pixel array 120 may be a plurality of liquid crystal display pixels. To be specific, in this embodiment, a plurality of pixel units of the pixel array 120 may be composed of a plurality of first color sub-pixels, a plurality of second color sub-pixels, a plurality of third color sub-pixels, and a plurality of fingerprint sensing pixels. The first to third color sub-pixels may be, for example, red color sub-pixels, green color sub-pixels, and blue color sub-pixels, but the invention is not limited thereto. It is worth noting that, in this embodiment, the plurality of color sub-pixels may be formed in a first semiconductor layer of the touch display panel 110, and the plurality of fingerprint sensing pixels may be formed in a second semiconductor layer of the touch display panel 110.

FIG. 2 is a schematic circuit diagram of a part of a pixel array of an embodiment of the invention. With reference to FIG. 1 and FIG. 2, a pixel unit 120P of FIG. 2 is the result of configuring one pixel in the pixel array 120. In this embodiment, the pixel unit 120P includes one first color sub-pixel 121, one second color sub-pixel 122, one third color sub-pixel 123, and one fingerprint sensing pixel 124. The first color sub-pixel 121, the second color sub-pixel 122, the third color sub-pixel 123, and the fingerprint sensing pixel 124 are electrically connected to a gate line G1. A gate line G2 is used to be electrically connected to pixel units in a next row, and so on. The first color sub-pixel 121 to the third color sub-pixel 123 are electrically connected to respectively display data lines D1 to D3. The fingerprint sensing pixel 124 is electrically connected to a sensing data line D4. A display data line D5 is used to be electrically connected to sub-pixels in a next column, and so on.

In this embodiment, the gate line G1 may be used to receive a scan signal to turn on the first color sub-pixel 121, the second color sub-pixel 122, the third color sub-pixel 123, and the fingerprint sensing pixel 124. In this embodiment, the display data lines D1 to D3 are used to transmit a plurality of display driving signals (display data) provided by the integrated chip 130 to the first color sub-pixel 121, the second color sub-pixel 122, and the third color sub-pixel 123, so that the first color sub-pixel 121, the second color sub-pixel 122, and the third color sub-pixel 123 respectively provide display functions according to the corresponding display driving signals (display data). In this embodiment, the sensing data line D4 is used to transmit a sensing signal of the fingerprint sensing pixel 124 to the integrated chip 130, so that the integrated chip 130 may generate a corresponding fingerprint sensing image according to the sensing signal. The sequence of arranging the color sub-pixels of the invention is not limited to the above. Moreover, the fingerprint sensing pixel 124 may also be placed at a position disposed between any two color sub-pixels.

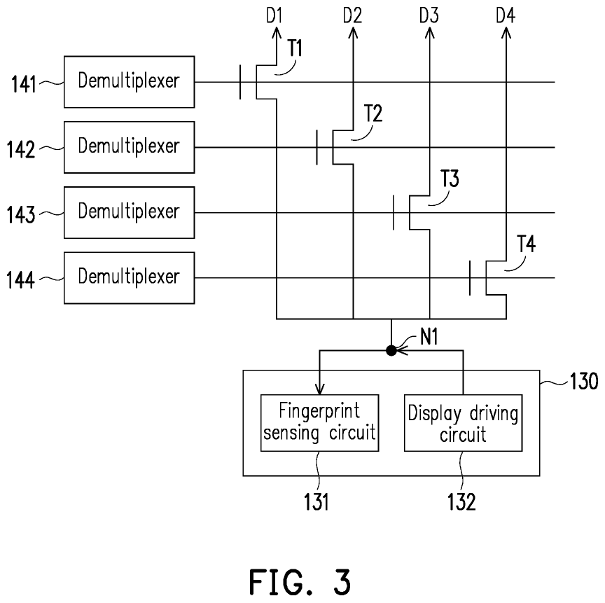

FIG. 3 is a schematic circuit diagram of an integrated chip and a switch circuit of an embodiment of the invention. With reference to FIG. 1 to FIG. 3, the integrated chip 130 includes the fingerprint sensing circuit 131 and the display driving circuit 132. In this embodiment, the fingerprint sensing circuit 131 and the display driving circuit 132 are electrically connected to terminals of switch transistors T1 to T4 through a same pin N1 (i.e., forming a common pin), and other terminals of the switch transistors T1 to T4 are electrically connected to the display data lines D1 to D3 and the sensing data line D4. Control terminals of the switch transistors T1 to T4 are electrically connected to respectively demultiplexers (DMUX) 141 to 144. In this embodiment, the demultiplexers 141 to 144 receive signals from the color sub-pixels 121 to 123 or the fingerprint sensing pixel 124 during different periods with switch signals of different timings to the switch transistors T1 to T4. The demultiplexers 141 to 144 may each be composed of one or more transistors or switch circuits, and the demultiplexers 141 to 144 may form one demultiplexer circuit.

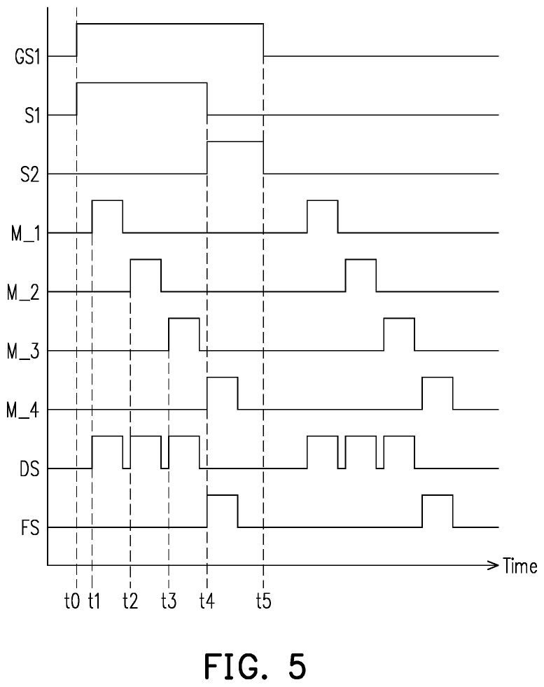

In this embodiment, the display data lines D1 to D3 and the sensing data line D4 are electrically connected to one column pixel group of the pixel array 120. The column pixel group may include a plurality of pixel units 120P as in the above-mentioned embodiment of FIG. 2 sequentially arranged along the display data lines. In other words, the fingerprint sensing circuit 131 and the display driving circuit 132 of the integrated chip 130 provide a plurality of data signals through the same pin N1 to the plurality of color sub-pixels in the one column pixel group electrically connected to the display data lines D1 to D3, and receive the sensing results of the plurality of fingerprint sensing pixels in the column pixel group through the sensing data line D4. Nonetheless, in an embodiment, the pin N1 may also be electrically connected to a plurality of other column pixel groups in the pixel array 120, or the integrated chip 130 may be electrically connected to a plurality of other column pixel groups in the pixel array 120 through a plurality of additional pins similar to the pin N1. In addition, timings of the plurality of switch signals, the plurality of display driving signals, and the sensing signals of this embodiment will be described in detail below with the embodiment of FIG. 5.

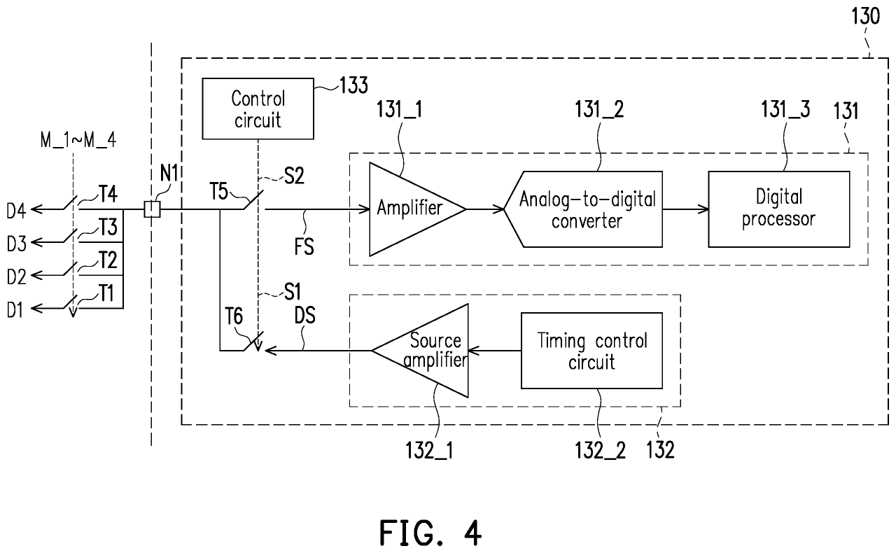

FIG. 4 is a schematic diagram of internal functional circuits of an integrated chip of an embodiment of the invention. With reference to FIG. 4, the integrated chip 130 includes the fingerprint sensing circuit 131, the display driving circuit 132, and a control circuit 133. In this embodiment, the control circuit 133 is electrically connected between the pin N1 and the fingerprint sensing circuit 131 through a first switch circuit, and electrically connected between the pin N1 and the display driving circuit 132 through a second switch circuit. The control circuit is used to alternately turn on the first switch circuit and the second switch circuit. In this embodiment, the first switch circuit may be a switch transistor T5, and the second switch circuit may be a switch transistor T6, but the invention is not limited thereto. One terminal of the switch transistor T5 is electrically connected to the pin N1, and one terminal of the switch transistor T6 is electrically connected to the pin N1 and one terminal of the switch transistor T5. Control terminals of the switch transistor T5 and the switch transistor T6 are electrically connected to the control circuit 133. The control circuit 133 may output two switch signals S1 and S2 to the switch transistor T5 and the switch transistor T6 to control the switch transistor T5 and the switch transistor T6.

In this embodiment, the fingerprint sensing circuit 131 includes an amplifier 131_1, an analog-to-digital converter 131_2, and a digital processor 131_3. An input terminal of the amplifier 131_1 is electrically connected to another terminal of the switch transistor T5. An input terminal of the analog-to-digital converter 131_2 is electrically connected to an output terminal of the amplifier 131_1. The digital processor 131_3 is electrically connected to an output terminal of the analog-to-digital converter 131_2. In this embodiment, the display driving circuit 132 includes a source amplifier 132_1 and a timing control circuit 132_2. An input terminal of the source amplifier 132_1 is electrically connected to the timing control circuit 132_2, and an output terminal of the source amplifier 132_1 is electrically connected to another terminal of the switch transistor T6. In this embodiment, the pin N1 is electrically connected to the switch transistors T1 to T4 at a side relative to the pin N1. The switch transistors T1 to T4 are electrically connected to the display data lines D1 to D3 and the sensing data line D4.

In this embodiment, the amplifier 131_1 may receive a sensing signal and provide a sensing signal FS after signal amplification to the analog-to-digital converter 131_2. The analog-to-digital converter 131_2 may provide a digital signal of the fingerprint sensing result to the digital processor 131_3, so that the digital processor 131_3 may generate fingerprint sensing information, for example, generating a fingerprint sensing image, according to the digital signal provided by the analog-to-digital converter 131_2. In this embodiment, the timing control circuit 132_2 of the display driving circuit 132 may provide a timing control signal to the source amplifier 132_1, so that the source amplifier 132_1 outputs a display driving signal DS according to the designed display timing.

FIG. 5 is a signal timing diagram of a plurality of signals for operating an integrated chip of an embodiment of the invention. With reference to FIG. 2 to FIG. 5, from time t0 to time t5 is a driving period of the pixel unit 120P (or a driving period of one column pixel group). The driving period includes a display driving period and a fingerprint sensing period, and the display driving period and the fingerprint sensing period are non-overlapped. For example, the display driving period is from time t0 to time t4. The fingerprint sensing period is from time t4 to time t5. In an embodiment, the color sub-pixels 121 to 123 and the fingerprint sensing pixel 124 of the pixel unit 120P receive a scan signal GS1 through the gate line G1 and are turned on from time t0 to time t5. In this embodiment, the switch transistor T6 receives the switch signal S1 and the switch transistor T5 receives the switch signal S2. The switch transistors T1 to T4 respectively receive switch signals M_1 to M_4 provided by the demultiplexers 141 to 144.

In this embodiment, the switch transistor T5 is turned off during the display driving period (from time t0 to time t4), and the switch transistor T6 is turned on during the display driving period (from time t0 to time t4). The display driving period includes three sub-display driving periods in the display driving period. The three sub-display driving periods are respectively from time t1 to time t2, from time t2 to time t3, and from time t3 to time t4. The switch transistors T1 to T3 respectively receive the switch signals M_1 to M_3 during the three sub-display driving periods and are turned on during different periods, and the switch transistor T4 are turned off. Signal waveforms of the switch signals M_1 to M_3 are temporally non-overlapped with each other. Therefore, the display driving circuit 132 respectively outputs first to third display driving signals (the square waveform of the display driving signal DS during the three sub-display driving periods as shown in FIG. 5) to the display data lines D1 to D3 through the pin N1 during different periods in the three sub-display driving periods.

In this regard, the display driving circuit 132 may output the display driving signal DS through the display data lines D1 to D3 to the color sub-pixels 121 to 123 during the display driving period, so that the pixel unit 120P performs the display function. Nonetheless, it should be noted that the display driving signal DS of FIG. 5 only represents the timing relationship of the signal waveform, instead of the real signal waveform. In this regard, the voltage level or the potential level of display data of the display driving signal DS may be determined by different display effects or individual types of sub-pixels, which is not limited by the invention.

In this embodiment, the switch transistor T5 is turned on during the fingerprint sensing period (from time t4 to time t5), and the switch transistor T6 is turned off during the fingerprint sensing period (from time t4 to time t5). The switch transistors T1 to T3 are turned off and the switch transistor T4 is turned on during the fingerprint sensing period. A signal waveform of the switch signal M_4 is non-overlapped with the signal waveforms of the switch signals M_1 to M_3. Therefore, the fingerprint sensing circuit 131 may receive the sensing signal FS from the fingerprint sensing pixel 124 through the sensing data line D4, so that the pixel unit 120P performs the fingerprint sensing function. Nonetheless, it should be noted that the sensing signal FS of FIG. 5 only represents the timing relationship of the signal waveform, instead of the real signal waveform. In this regard, the voltage level or the potential level of sensing data of the sensing signal FS may be determined by different sensing results.

In summary of the foregoing, in the electronic device of the invention, an in-cell-type fingerprint, touch, and display panel architecture is implemented, and an FTDDI chip is used to drive the touch display panel embedded with a plurality of fingerprint sensing pixels. Therefore, the electronic device of the invention can save the space occupied by the driving circuit in the peripheral area of the panel. Alternatively, the integrated chip of the invention may transmit the display driving signal and the sensing signal through the same pin, and can effectively save the space occupied by pins and circuits in the peripheral area of the panel.

Lastly, it should be noted that the above embodiments are only used for describing, instead of limiting, the technical solutions of the invention. Although the invention has been described in detail with reference to the above embodiments, those of ordinary skill in the art should understand that modification to the technical solutions recited in the above embodiments or equivalent replacement of some or all of the technical features therein may still be made. Nonetheless, the nature of the corresponding technical solutions so modified or replaced does not depart from the scope of the technical solutions of the embodiments of the invention.

What is claimed is:

1. An electronic device, comprising:
a touch display panel, comprising a pixel array; and
an integrated chip, electrically connected to the pixel array, and comprising a fingerprint sensing circuit and a display driving circuit,
wherein the fingerprint sensing circuit and the display driving circuit are electrically connected to a plurality of display data lines and sensing data lines through a same pin,
wherein the plurality of display data lines are electrically connected to respectively a plurality of color sub-pixels of the pixel array, and the sensing data lines are electrically connected to a plurality of fingerprint sensing pixels of the pixel array, wherein the plurality of color sub-pixels are a plurality of liquid crystal display pixels.

2. The electronic device according to claim 1, wherein the pin is electrically connected to the plurality of display data lines through a plurality of transistors, and the pin is electrically connected to the sensing data lines through another transistor.

3. The electronic device according to claim 2, wherein control terminals of the plurality of transistors respectively receive a plurality of switch signals, and signal waveforms of the plurality of switch signals are temporally non-overlapped.

4. The electronic device according to claim 1, wherein the display driving circuit outputs a plurality of display driving signals through the pin during a display driving period to drive the plurality of color sub-pixels, and the fingerprint sensing circuit receives sensing signals of the plurality of fingerprint sensing pixels through the pin during a fingerprint sensing period, wherein the display driving period and the fingerprint sensing period are non-overlapped.

5. The electronic device according to claim 4, wherein the display driving period comprises a plurality of sub-display driving periods, and the display driving circuit respectively outputs the plurality of display driving signals through the pin to the plurality of display data lines during different periods in the plurality of sub-display driving periods.

6. The electronic device according to claim 1, wherein the integrated chip further comprises:
a first switch circuit, having one terminal electrically connected to the pin, and having another terminal electrically connected to the fingerprint sensing circuit;
a second switch circuit, having one terminal electrically connected to the pin, and having another terminal electrically connected to the display driving circuit; and
a control circuit, electrically connected to the first switch circuit and the second switch circuit, wherein the control circuit alternately turns on the first switch circuit and the second switch circuit.

7. The electronic device according to claim 6, wherein the fingerprint sensing circuit comprises:
an amplifier, having an input terminal electrically connected to the another terminal of the first switch circuit;
an analog-to-digital converter, having an input terminal electrically connected to an output terminal of the amplifier; and
a digital processor, electrically connected to an output terminal of the analog-to-digital converter.

8. The electronic device according to claim 6, wherein the display driving circuit comprises:
a timing control circuit; and
a source amplifier, having an input terminal electrically connected to the timing control circuit, and having an output terminal electrically connected to the another terminal of the second switch circuit.

9. The electronic device according to claim 1, wherein the plurality of color sub-pixels are formed in a first semiconductor layer of the touch display panel, and the plurality of fingerprint sensing pixels are formed in a second semiconductor layer of the touch display panel.

10. The electronic device according to claim 1, wherein the plurality of color sub-pixels comprise at least one red sub-pixel, at least one green sub-pixel, and at least one blue sub-pixel.

11. The electronic device according to claim 1, wherein the integrated chip further comprises a touch driving circuit.
